(19) United States
(12) Patent Application Publication
(10) Pub. No.: US 2015/0192029 A1
(43) Pub. Date: Jul. 9, 2015

(54) TURBOMACHINE BLADE TIP INSERT

(71) Applicant: General Electric Company, (US)

(72) Inventors: Herbert Chidsey Roberts, III, Simpsonville, SC (US); Glenn Curtis Taxacher, Simpsonville, SC (US); John McConnell Delvaux, Fountain Inn, SC (US)

(73) Assignee: GENERAL ELECTRIC COMPANY, Schenectady, NY (US)

(21) Appl. No.: 13/623,854

(22) Filed: Sep. 20, 2012

(51) Int. Cl. F01D 11/12; F01D 5/14

(52) U.S. Cl. CPC F01D 11/12; F01D 5/147; F05D 2220/32

(57) ABSTRACT

Embodiments of the present disclosure are directed toward systems including a tip shroud insert having a retained portion configured to be retained within a pocket of a turbomachine blade and an exposed portion configured to form a dynamic seal with a stationary structural component surrounding the turbomachine blade.

### STATEMENT REGARDING FEDERALLY SPONSORED RESEARCH & DEVELOPMENT

This invention was made with Government support under grant number DE-FC26-05NT42643-ARRA awarded by the Department of Energy. The Government has certain rights in the invention.

### BACKGROUND OF THE INVENTION

The subject matter disclosed herein relates to turbomachines, and, more particularly, to improved tips for a turbomachine blade.

Turbomachines include compressors and turbines, such as gas turbines, steam turbines, and hydro turbines. Generally, turbomachines include a rotor, which may be a shaft or drum, to which turbomachine blades are attached. Certain turbomachine blades may include tip shrouds to meet structural and/or performance requirements. For example, the tip shroud of a turbomachine blade may reduce leakage or cross flow from a pressure side (e.g., a concave face) to a suction side (e.g., a convex face) side of the turbomachine blade. However, the tip shroud may be subjected rubbing and/or abrasion against a stationary structural component (e.g., a stationary or static shroud) surrounding the turbomachine blades. To avoid rubbing and/or abrasion against a stationary structural component, a gap or clearance may be created between traditional tip shrouds and stationary structural components, which can decrease the efficiency of the turbomachine with increasing size of the gap.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a tip shroud insert having a retained portion configured to be retained within a pocket of a turbomachine blade and an exposed portion configured to form a dynamic seal with a stationary structural component surrounding the turbomachine blade.

In a second embodiment, a system includes a turbomachine blade having a pocket formed in a radial end of the turbomachine blade. The system further includes a tip shroud insert having a retained portion disposed within the pocket and an exposed portion coupled to the retained portion, wherein the exposed portion extends radially outward from the radial end of the turbomachine blade.

In a third embodiment, a system includes a turbomachine having a turbomachine blade and a removable tip shroud insert disposed within a pocket of the turbomachine blade, wherein the pocket is formed at a radial end of the turbomachine blade, and the removable tip shroud insert is configured to form a dynamic seal between the turbomachine blade and a stationary structural component of the turbomachine.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic block diagram of an embodiment of a gas turbine system having blades with tip shroud inserts;

FIG. 2 is a partial side view, taken within line 2-2 of FIG. 1, of a turbomachine (e.g., a turbine) having a turbomachine blade with a tip shroud insert, in accordance with embodiments of the present disclosure;

FIG. 3 is a partial perspective view of an embodiment of a turbomachine blade with a tip shroud insert; and

FIG. 4 is a partial perspective view of an embodiment of a turbomachine blade with a tip shroud insert.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include improved tip shrouds for turbomachine blades. More specifically, the tip shrouds described below include a tip shroud insert that may be at least partially inserted into a pocket or recess formed at a radial end of the turbomachine blade. That is, the tip shroud insert is independent of the turbomachine blade and can be replaced or repaired without dramatically modifying the material properties of the turbomachine blade. As a result, the tip shroud insert and the turbomachine blade may be made from different materials. In certain embodiments, the tip shroud insert may be made from an abradable material or other material that may tolerate or absorb contact with the stationary structural component. Thus, any contact may occur at lower friction and/or may abrade the insert rather than other parts. Additionally, the turbomachine blade may be made from materials such as ceramics, composites, polymers, or materials having advanced or complex material properties. As discussed below, the tip shroud insert may be configured to maintain and provide a dynamic seal across the suction and pressure sides of the turbomachine blade. For example, the tip shroud insert may provide a point of contact (or tighter clearance) between the turbomachine blade and a stationary structural component, such as a shroud, surrounding the turbomachine blades, thereby providing a seal between the suction and pressure sides of the turbomachine blade. In this manner, unwanted contact between the turbomachine blade and a stationary structural component may be blocked or avoided, thereby reducing damage or degradation of the turbomachine blade. While the disclosed improved tip shrouds may be utilized with turbomachine blades of a variety of turbomachines (e.g., turbines and compressors), the following discussion describes improved tip shrouds in the context of a turbine, such as a gas turbine or a steam turbine. However, it is important to note that the following discussion is not intended to limit the application of the disclosed improved tip shrouds to turbines.

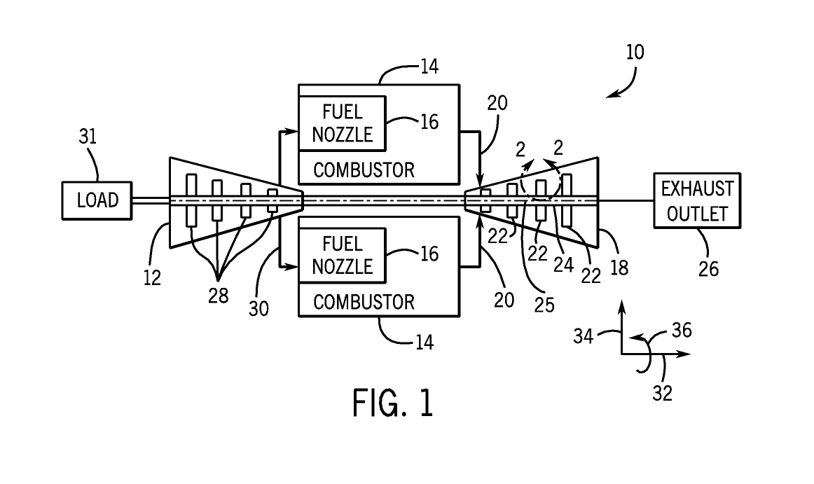

Turning now to the drawings, FIG. 1 is a schematic block diagram of an embodiment of a gas turbine system 10 having turbine blades 22 with improved tip shrouds (e.g., tip shroud inserts). The gas turbine system 10 includes a compressor 12, combustors 14 having fuel nozzles 16, and a turbine 18. The fuel nozzles 16 route a liquid fuel and/or gas fuel, such as natural gas or syngas, into the combustors 14. The combustors 14 ignite and combust a fuel-air mixture, and then pass hot pressurized combustion gases 20 (e.g., exhaust) into the turbine 18. The turbine blades 22 are coupled to a rotor 24, which is also coupled to several other components throughout the gas turbine system 10, as illustrated. As the combustion gases 20 pass through the turbine blades 22 in the turbine 18, the turbine 18 is driven into rotation, which causes the rotor 24 to rotate along a rotational axis 25. Eventually, the combustion gases 20 exit the turbine 18 via an exhaust outlet 26.

In the illustrated embodiment, the compressor 12 includes compressor blades 28. The compressor blades 28 within the compressor 12 are also coupled to the rotor 24, and rotate as the rotor 24 is driven into rotation by the turbine 18, as described above. It is important to note that the disclosed improved tip shrouds may also be used in conjunction with the compressor blades 28. As the compressor blades 28 rotate within the compressor 12, the compressor blades 28 compress air from an air intake into pressurized air 30, which is routed to the combustors 14, the fuel nozzles 16, and other portions of the gas turbine system 10. The fuel nozzles 16 then mix the pressurized air and fuel to produce a suitable fuel-air mixture, which combusts in the combustors 14 to generate the combustion gases 20 to drive the turbine 18. Further, the rotor 24 may be coupled to a load 31, which may be powered via rotation of the rotor 24. For example, the load 31 may be any suitable device that may generate power via the rotational output of the gas turbine system 10, such as a power generation plant or an external mechanical load. For instance, the load 31 may include an electrical generator, a propeller of an airplane, and so forth. In the following discussion, reference may be made to various directions, such as an axial direction or axis 32, a radial direction or axis 34, and a circumferential direction or axis 36 of the turbine 18.

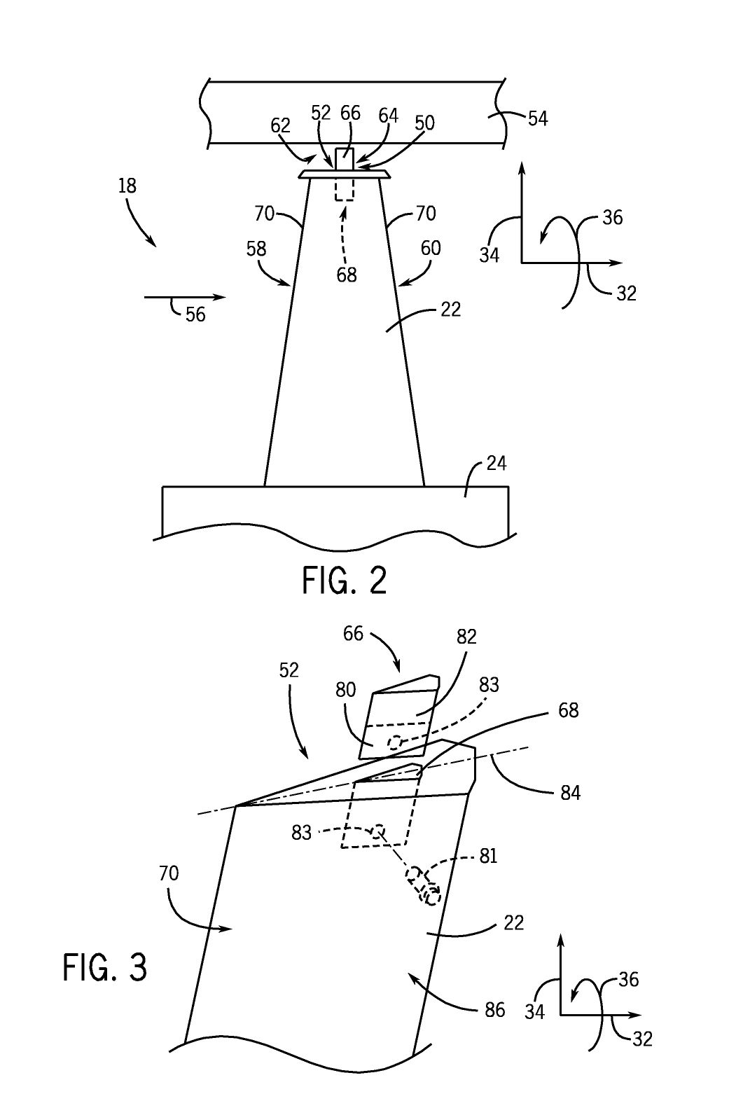

FIG. 2 is a partial side view, taken within line 2-2 of FIG. 1, of the turbine 18, illustrating a turbine blade 22 (e.g., airfoil) having a tip shroud 50. As will be appreciated, the tip shroud 50 may serve to block tip leakage between a radial end 52 of the turbine blade 22 and a stationary structural component 54. For example, the stationary structural component 54 may be a turbine casing, housing, shroud, and so forth. In other words, the tip shroud 50 may help block a fluid flow 56 (e.g., of the combustion gases 20 from the combustor 14) within the turbine 18 from passing from a pressure side 58 to a suction side 60 of the turbine blade 22 through a clearance 62 between the radial end 52 of the turbine blade 22 and the stationary structural component 54. The tip shroud 50 may also include a labyrinth seal 64, which further blocks the fluid flow 56 from passing from the pressure side 58 to the suction side 60 through the clearance 62.

In the illustrated embodiment, the tip shroud 50 includes a tip shroud insert 66, which extends in the radial direction 34 towards the stationary structural component 54. More specifically, the tip shroud insert 66 is inserted into a pocket 68 formed in the radial end 52 of the turbine blade 22. That is, the tip shroud insert 66 is retained within the pocket 68 and extends radially 34 outward from the radial end 52 of the turbine blade 22 towards the stationary structural component 54. As discussed in detail below, the tip shroud insert 66 may be retained within the pocket 68 of the turbine blade 22 in a variety of manners. For example, the tip shroud insert 66 may be held in the pocket 68 by an adhesive, a mechanical fastener (e.g., a bolt), a frictional fit, interference fit, a weld or braze, a dovetail joint, a snap-fit coupling, a lock pin, other retaining mechanism, or any combination thereof.

Additionally, the tip shroud insert 66 may be made of a variety of materials, such as abradable materials. As will be appreciated, an abradable material may be configured to withstand, tolerate, or absorb contact with the stationary structural component 54 as the turbine blade 22 rotates within the stationary structural component 54 (e.g., rotates about the shaft 25). As mentioned above, the tip shroud insert 66 may be the point of contact between the turbine blade 22 and the stationary structural component 54 and may maintain a seal across the pressure side 58 and the suction side 60 of the turbine blade 22. In this manner, direct contact between the turbine blade 22 and the stationary structural component 54 may be reduced, thereby reducing localized rub damage and degradation to the turbine blade 22. As will be appreciated, the reduction of contact between the turbine blade 22 and the stationary structural component 54 may enable usage of complex and/or composite materials that may otherwise be degraded or damaged by contact with the stationary structural component 54 during operation of the turbine 18.

As discussed below, the geometry of the tip shroud insert 66 may vary. For example, in the illustrated embodiment, the tip shroud insert 66 extends laterally from an outer surface 70 of the turbine blade 22 about a perimeter of the turbine blade 22. However, in other embodiments, the tip shroud insert 66 may merely extend radially 34 outward from the radial end 52 of the turbine blade 22. Furthermore, as described below, the tip shroud insert 66 may have other variations in geometry.

FIG. 3 is a partial perspective view of the turbine blade 22 with the tip shroud insert 66. As discussed above, the tip shroud insert 66 is inserted into the pocket 68 formed in the radial end 52 of the turbine blade 22, and the tip shroud insert 66 extends radially 34 outward from the radial end 52 of the turbine blade 22. In other words, the tip shroud insert 66 includes a retained portion (e.g., a blade mounting portion) 80 and an exposed portion (e.g., a dynamic seal portion) 82. As will be appreciated, the retained portion 80 is retained within the pocket 68 of the turbine blade 22, and the exposed portion 82 extends from the radial end 52 towards the stationary structural component 54. The exposed portion 82 may also extend laterally towards and/or beyond the outer surfaces 70 of the turbine blade 22.

As mentioned above, the tip shroud insert 66 may be retained within the pocket 68 using a variety of methods. For example, the retained portion 80 may be held within the pocket 68 by an adhesive (e.g., glue), a mechanical fastener (e.g., a bolt), a frictional fit, an interference fit, a weld or braze, a dovetail joint, a snap-fit coupling, a lock pin, other retaining mechanism, or any suitable combination thereof. For example, the illustrated embodiment includes a bolt 81 which may be secured within apertures 83 formed in the tip shroud insert 66 and the turbine blade 22, thereby securing the retained portion 80 of the tip shroud insert 66 within the turbine blade 22.

Furthermore, the tip shroud insert 66 may be formed from a variety of materials. For example, the tip shroud insert 66 may be made from a single material or from multiple materials. In certain embodiments, the retained portion 80 may be made from a first material, and the exposed portion 82 may be made from a second material. As mentioned above, materials used to make the tip shroud insert 66 may be abradable materials or other materials configured to withstand, tolerate, or absorb contact with the stationary structural component 54 surrounding the turbine blades 22. Exemplary materials that may be used to make the tip shroud insert 66 include graphite, Kevlar, aluminum oxide, tungsten, titanium, ceramics or other suitable material.

The tip shroud insert 66 serves as a contact point (or small clearance point) between the turbine blade 22 and the stationary structural component 54. In this manner, the tip shroud insert 66 helps create a dynamic seal between the turbine blade 22 and the stationary structural component 54, thereby reducing flow leakage from the pressure side 58 to the suction side 60 of the turbine blade 22 through the clearance 62 between the radial end 52 of the turbine blade 22 and the stationary structural component 54. In different embodiments, the size of the tip shroud insert 66 may vary. For example, the tip shroud insert 66 may extend along the entire length of a chord 84 of the turbine blade 22, or a partial length of the chord 84. Additionally, the tip shroud insert 66 may have various widths. In certain embodiments, the tip shroud insert 66 may be centered along the chord 84 of the turbine blade 22, while in other embodiments the tip shroud insert 66 may be offset (e.g., towards the pressure side 58 or suction side 60 and/or towards a leading edge or trailing edge of the turbine blade 22).

Furthermore, as the tip shroud insert 66 serves as the contact point between the turbine blade 22 and the stationary structural component 54, direct contact between the turbine blade 22 and the stationary structural component 54 may be blocked or avoided. In other words, damage or wear to the tip shroud insert 66 is not transferred to the material of the turbine blade 22. Consequently, the turbine blade 22 may be made from complex and/or composite materials (e.g., polymers or ceramic-based composites) that would otherwise be damaged by contact with the stationary structural component 54. For example, the turbine blade 22 may be made from a composite material having a matrix material and a fiber material distributed throughout the matrix material. As will be appreciated, such turbine blades 22 may be formed with a plurality of layers or laminates of the composite material. Alternatively, the turbine blade 22 may be made with a metal using a casting or electrical discharge machining process. Additionally, in certain embodiments, the turbine blade 22 may have a surface treatment or coating 86, such as an environmental barrier coating, that may otherwise be eroded, abraded, or rubbed off by direct contact with the stationary structural component 54. For example, the surface coating 86 may be a silicon oxide, rare earth element (e.g., ytterbium), an oxygen or hydrogen inhibitor, or other coating.

As mentioned above, the tip shroud insert 66 may be removed and/or replaced as needed. For example, the tip shroud insert 66 may be replaced at periodic intervals throughout the life or operation of the turbine 18. Additionally, the tip shroud insert 66 may be replaced after experiencing a threshold amount of wear or degradation. As will be appreciated, replacement of the tip shroud insert 66 may be considerably less complicated and less costly than replacement of the turbine blade 22.

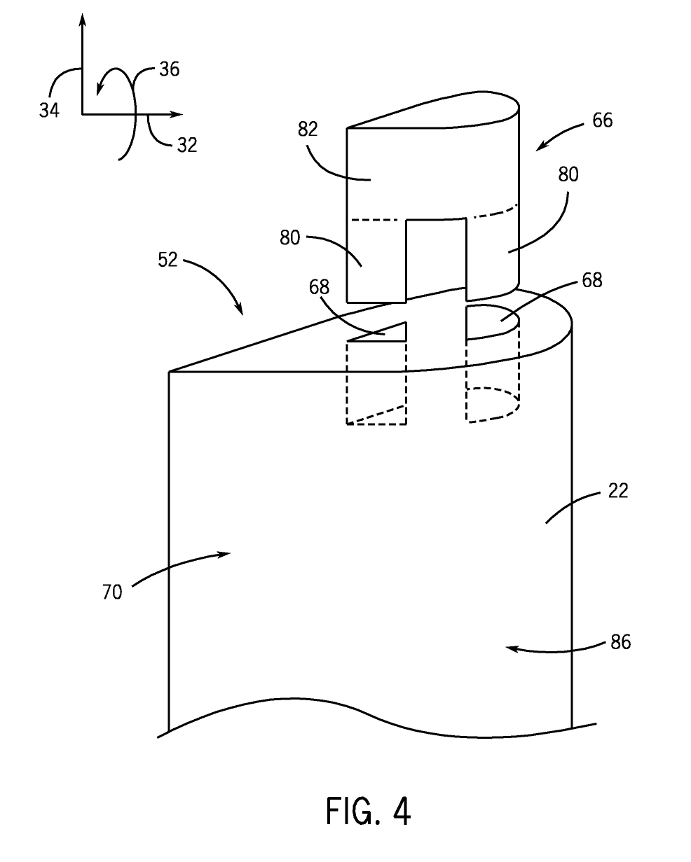

FIG. 4 is a partial perspective view of the turbine blade 22 with the tip shroud insert 66. Specifically, the illustrated embodiment of the tip shroud insert 66 includes two retained portions 80. Accordingly, the radial end 52 of the turbine blade 4 22 has two pockets 68, each pocket 68 configured to receive one retained portion 80 of the tip shroud insert 66. However, other embodiments of the tip shroud insert 66 and the turbine blade 22 may include other numbers of retained portions 80 and respective pockets 68.

As discussed in detail above, the disclosed embodiments are directed towards improved turbomachine blade tip shrouds 50. More specifically, embodiments of the tip shroud 50 described above may include the tip shroud insert 66, which is retained in the pocket 68 formed in the radial end 52 of the turbine blade 22. The tip shroud insert 66 serves as the contact point between the turbine blade 22 and the stationary structural component 54 (e.g., shroud) surrounding the turbine blade 22 to create a dynamic seal between the turbine blade 22 and the stationary structural component 54. In this manner, direct contact between the turbine blade 22 and the stationary structural component 54 may be avoided during operation of the turbine 18 (e.g., rotating of the turbine blades 22). Accordingly, the turbine blade 22 may be made from a material that would otherwise be damaged or degraded by direct contact with the stationary structural component 54, while the tip shroud insert 66 may be made from an abradable material configured to withstand, tolerate, or absorb direct contact with the stationary structural component 54.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a tip shroud insert, comprising:
a blade mounting portion configured to be retained within a pocket of a turbomachine blade; and
a dynamic seal portion configured to form a dynamic seal with a stationary structural component surrounding the turbomachine blade.

2. The system of claim 1, wherein the blade mounting portion is configured to mount within the pocket by an adhesive, a mechanical retainer, a frictional fit, or a combination thereof.

3. The system of claim 1, comprising the turbomachine blade having the tip shroud insert.

4. The system of claim 3, wherein the pocket is formed in a radial end of the turbomachine blade.

5. The system of claim 1, wherein the tip shroud insert is made of graphite, Kevlar, aluminum oxide, tungsten, titanium, a ceramic, or a combination thereof.

6. The system of claim 1, wherein the dynamic seal portion of the tip shroud insert is configured to extend beyond a pressure surface or a suction surface of the turbomachine blade.

7. The system of claim 1, wherein the tip shroud insert is configured to extend along a chord of the turbomachine blade.

8. The system of claim 7, wherein the turbomachine blade is made from a composite material having a matrix material and a fiber material distributed in the matrix material.

9. The system of claim 7, wherein the turbomachine blade comprises a surface coating.

10. The system of claim 7, comprising a turbomachine having the turbomachine blade and the tip shroud insert.

11. A system, comprising:
a turbomachine blade, comprising:
a pocket formed in a radial end of the turbomachine blade; and
a tip shroud insert, comprising:
a blade mounting portion disposed within the pocket; and
a dynamic seal portion coupled to the retained portion, wherein the exposed portion extends radially outward from the radial end of the turbomachine blade.

12. The system of claim 11, wherein the retained portion is retained within the pocket by an adhesive, a mechanical fastener, frictional fit, or a combination thereof.

13. The system of claim 11, wherein the turbomachine blade and the tip shroud insert are made from different materials.

14. The system of claim 11, wherein the tip shroud insert is made from graphite, Kevlar, aluminum oxide, tungsten, titanium, a ceramic, or a combination thereof.

15. The system of claim 11, wherein the turbomachine blade is formed from a composite material having a matrix material and a fiber material distributed in the matrix material.

16. The system of claim 11, wherein the tip shroud insert is configured to form a dynamic seal between a stationary structural component and the turbomachine blade.

17. The system of claim 11, wherein the dynamic seal portion of the tip shroud insert extends beyond a pressure surface or a suction surface of the turbomachine blade.

18. A system, comprising:
a turbomachine, comprising:
a turbomachine blade; and
a removable tip shroud insert disposed within a pocket of the turbomachine blade, wherein the pocket is formed at a radial end of the turbomachine blade, and the removable tip shroud insert is configured to form a dynamic seal between the turbomachine blade and a stationary structural component of the turbomachine.

19. The system of claim 18, wherein the removable tip shroud insert is made of graphite, Kevlar, aluminum oxide, tungsten, titanium, a ceramic, or a combination thereof.

20. The system of claim 18, wherein the removable tip shroud insert is retained within the pocket by an adhesive, a mechanical fastener, frictional fit, or a combination thereof.
